(19) United States
(12) Patent Application Publication
(10) Pub. No.: US 2008/0030172 A1
(43) Pub. Date: Feb. 7, 2008

(54) BATTERY CHARGER WITH THERMAL REGULATION AND SOFT START

(75) Inventor: Saul Darzy, Edgware (GB)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: STMicroelectronics Limited, London (GB)

(21) Appl. No.: 11/829,760

(22) Filed: Jul. 27, 2007

(30) Foreign Application Priority Data
Jul. 27, 2006 (EP) EP 06253928.3

(51) Int. Cl. H02J 7/00

(52) U.S. Cl. 320/153; 320/150

(57) ABSTRACT

A battery charger is provided which has a power output to charge a battery. The battery charger comprises a power input and a circuit for determining a temperature at the battery charger. The battery charger further includes a controller which varies the power output among a plurality of non-zero power levels in dependence upon the difference between the determined temperature and a reference temperature.

### PRIORITY CLAIM

The present application claims priority from European Application No. 06253928.3 of the same title filed Jul. 27, 2006, the disclosure of which is hereby incorporated by reference to the maximum extent allowable by law.

### BACKGROUND OF THE INVENTION

1. Technical Field of the Invention

The present invention relates to thermal regulation of a battery charger.

2. Description of Related Art

Battery chargers supply power to a battery, thereby causing the charge stored in the battery to be increased. When the battery charger is operated, power dissipation in the components of the battery charger, together with the thermal properties of the components and casing, may cause the battery charger to become hot. An excessive temperature may damage the device. For example, when the battery charger is implemented in an integrated circuit, the die temperature may rise beyond an acceptable limit.

Existing battery chargers use a thermal shut down mechanism. FIG. 1 shows a schematic diagram of a prior art battery charger with a thermal shutdown mechanism. The battery charger comprises a power input 10; a temperature sensor 20, having an output 25; a power output 30; and a controller 40. The controller also has a threshold input 60 and subtracts the output of the temperature gauge from this threshold input, passing this to Schmidt trigger 70. The Schmidt trigger generates a logical output which is a control signal 80 for a power switch 50. The Schmidt trigger operates according to a hysteretic function, such that its output changes from logical 0 to logical 1 at a different input as it changes from logical 1 to logical 0. When the control signal is a logical 1, the power switch allows power to flow from the power input to the power output. When the control signal is a logical 0, the power switch prevents power from flowing from the power input to the power output.

Existing battery chargers thereby prevent power output when the temperature of the device rises above a first acceptable limit, until the temperature of the device reduces to below a second acceptable limit. This thermal shutdown increases the battery charging time.

### SUMMARY OF THE INVENTION

An embodiment provides a battery charger having a power output to charge a battery comprising a power input; means for determining a temperature within the battery charger; and a controller, adapted to vary the power output among a plurality of non-zero power levels, in dependence upon the size of the difference between the determined temperature and a reference temperature.

Preferably, the means for determining a temperature is adapted to measure the power output and to determine the temperature at the battery charger based upon the measured power output. Advantageously, the means for determining a temperature is arranged according to a thermal model for determining the dynamic variation in the temperature. This advantageously may improve the stability of the thermal regulation feedback loop.

Preferably, the controller comprises a first comparator, arranged to generate a first control signal in dependence upon the difference between the measured temperature and the reference temperature. Optionally, the comparator may comprise an operational amplifier. Advantageously, the first control signal comprises variations in an electrical current.

In a preferred embodiment, the power output of the battery charger has an output current and the battery charger further comprises a current meter for measuring the output current; and the controller is further adapted to vary the power output in dependence upon the output current. Optionally, the controller comprises a second comparator, arranged to generate a second control signal. The second control signal may optionally comprise variations in an electrical current.

Also in a preferred embodiment the power output of the battery charger has an output voltage; the battery charger further comprises a voltage meter for measuring the output voltage; and the controller is further adapted to vary the power output in dependence upon the output voltage. Optionally, the controller comprises a third comparator, arranged to generate a third control signal. The third control signal may optionally comprise variations in an electrical current. Alternatively, the first, second and third control signals may each comprise variations in an electrical voltage, or may comprise digital signals.

Preferably at least a part of the battery charger comprises components fabricated on an integrated circuit. Alternatively, discrete components may be used.

In another embodiment, a method of charging a battery using a battery charger having a power output comprises: determining a temperature at the battery charger; and varying the power output of the battery charger among a plurality of non-zero power levels, in dependence upon the size of the difference between the determined temperature and a reference temperature.

Preferably, determining comprises: measuring the power output; and determining the temperature at the battery charger based upon the measured power output. In the preferred embodiment, determining the temperature based on the measured power output determines dynamic variations in the temperature according to a thermal model.

### BRIEF DESCRIPTION OF THE DRAWINGS

The invention may be put into practice in various ways, one of which will now be described by way of example only and with reference to the accompanying drawings in which:

FIG. 1 shows a schematic diagram of a battery charger having a thermal shutdown mechanism according to the prior art;

FIG. 2 shows a schematic diagram of a battery charger having a thermal regulation mechanism according to a first aspect of the present invention;

FIG. 3 shows a circuit diagram of an embodiment of the battery charger of FIG. 2;

FIG. 4 shows a circuit diagram of the embodiment of the battery charger of FIG. 3, additionally having output current regulation circuitry, comprising a soft start circuit; and output voltage regulation circuitry;

FIG. 5 shows schematic layout of an integrated circuit embodiment of a part of the battery charger of FIG. 4; and

FIG. 6A shows a graph of temperature against time for the battery charger of FIG. 4 and FIG. 5 in a first case;

FIG. 6B shows a graph of temperature against time for the battery charger of FIG. 4 and FIG. 5 in a second case;

FIG. 7 shows a circuit diagram of temperature gauge for use in the circuit of FIG. 4, arranged according to a thermal model of the integrated circuit embodiment of FIG. 5;

FIG. 8A shows a time response of the thermal model of FIG. 7 in the first case, corresponding with FIG. 6A;

FIG. 8B shows a time response of the thermal model of FIG. 7 in the second case, corresponding with FIG. 6B;

FIG. 9 shows a frequency response of the thermal model of FIG. 7; and

FIG. 10 shows a circuit diagram of a soft start circuit for use in the battery charger of FIG. 4.

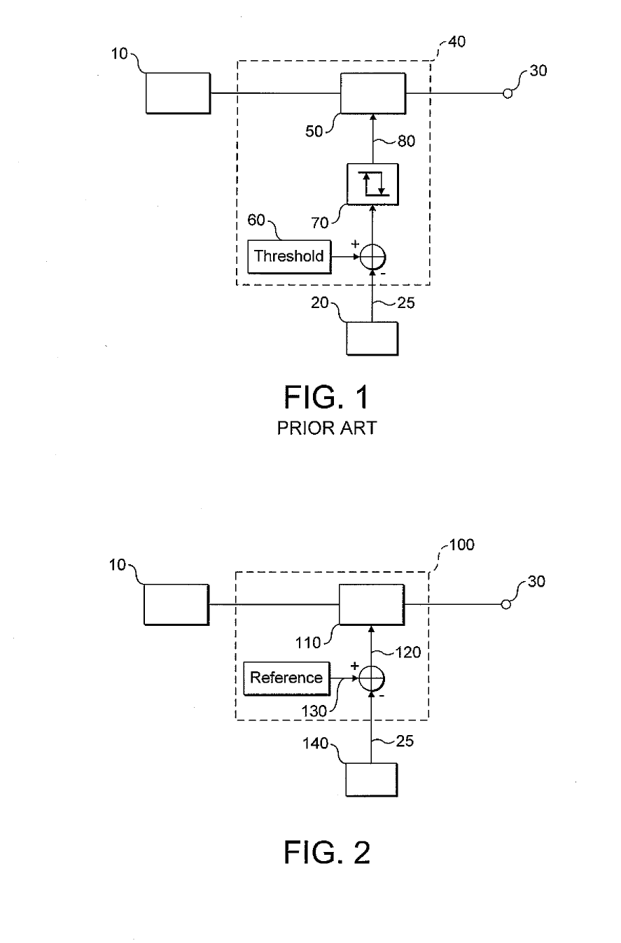

### DETAILED DESCRIPTION OF THE DRAWINGS

Referring first to FIG. 2, a schematic diagram of an embodiment of a battery charger is shown.

The battery charger comprises a power input 10; a temperature gauge 140 for determining a temperature within the battery charger and having an output 25; and a power output 30. The power output may be adapted to receive a battery to be charged. The battery charger further comprises a controller 100, which controls the power output.

The controller comprises a power control circuit 110, which controls the flow of power from the power input to the power output and may thereby vary the power output among a plurality of values, at least two of the values being non-zero. The power control circuit is controlled by a control signal 120. The control signal is generated by subtracting the output of the temperature gauge from a reference 130.

The battery charger therefore operates a thermal regulation feedback loop. The power input 10 provides a power. The power control circuit 110 is a driver circuit which controls the power output 30. Power is dissipated in the power control circuit, causing the temperature within the battery charger to increase. The temperature is determined by the temperature gauge 140 and the temperature output 25 is subtracted from a reference 130 to generate the control signal 120. The greater the difference between the determined temperature and the reference, the larger the control signal.

As the size of the control signal increases, the power control circuit increases its variation of the power output. When the control signal is positive, the power control circuit may increase the power output, thereby increasing power dissipation. This may increase temperature. When the control signal is negative the power control circuit may decrease the power output, thereby decreasing power dissipation and hence reducing the temperature within the battery charger.

For effective thermal regulation, it is desirable that the feedback loop is stable. To ensure this, it is desirable that the determined temperature take account of dynamic thermal behavior of the battery charger. The circuit advantageously incorporates this to provide a stable feedback loop.

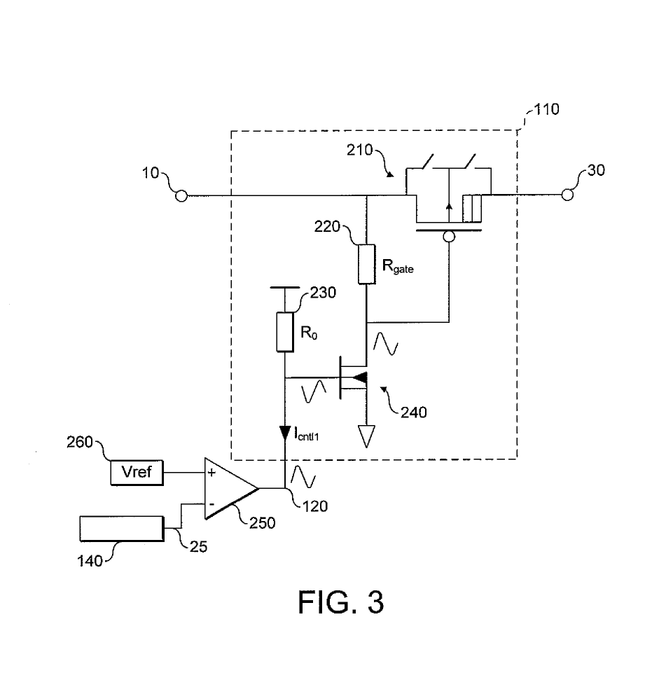

FIG. 3 shows a circuit diagram of an embodiment of part of the battery charger of FIG. 2. The circuit comprises a power input 10 and power output 30. The circuit further comprises a reference voltage generator 260 and a temperature gauge 140 having a voltage output 25. These are both coupled to an operational amplifier 250 acting as a comparator, which provides a control signal 120. The control signal is provided to a power control circuit 110.

The power control circuit comprises a resistor 230 of resistance R₀; a driver transistor 240; a gate resistor 220 of resistance R_{gate}; and a power transistor 210. The control signal is coupled to one end of the resistor 230. The other end of the resistor 230 is coupled to a fixed positive voltage. The control signal is also coupled to the gate of the driver transistor. The drain of the driver transistor is grounded. The source of the driver transistor is coupled to one end of the gate resistor 220 and to the gate of the power transistor 210. The other end of the gate resistor 220 is coupled to the source of the power transistor 210. The drain of the power transistor is coupled to the power output 30.

The power control circuit thereby controls the power flowing from the power input to the power output according to the control signal 120. The arrangement of the resistor 230 determines that the control signal 120 comprises a variation in current (I_{cntl1}). The operational amplifier 250 is therefore a transconductance amplifier. The lower the output of the temperature gauge with respect to the reference voltage, the greater the current (I_{cntl1}). The greater this current, the greater the gate voltage at the power transistor 210 and hence the greater the power output at 30.

The greater the output of the temperature gauge with respect to the reference voltage, the lower the current comprising the control signal 120. The lower this current, the lower the gate voltage at the power transistor 210 and hence the lower the power output at 30.

This circuit thereby provides negative feedback, since when the temperature increases above a reference, the power output is reduced and when the temperature decreases below the reference, the power output is increased. The power output comprises a charging current which flows into the battery to be charged.

Advantageously, the battery charger may additionally provide current and voltage regulation. FIG. 4 shows the circuit diagram of the battery charger of FIG. 3 further comprising current and voltage regulation circuitry.

The circuit additionally comprises a current meter 310; a current control operational amplifier 320; a soft start circuit 330; and a voltage control operational amplifier 340.

In the preferred embodiment, the current meter 310 comprises a current sense resistor 311, of resistance Rₛₑₙₛₑ; a first resistor 312 of resistance Rᵥ; a transistor 313; an operational amplifier 314; and a second resistor 315 of resistance Rₛₑₜ. The output of the current meter 316 is a voltage signal representative of the current flowing through resistor 311.

The output of the current meter is provided to the current control operational amplifier 320. The reference voltage 260 is provided to the soft start circuit 330. The output of the soft start circuit is provided to the current control operational amplifier 320. The soft start circuit is adapted to vary its output when switching on, to ramp up the power output slowly, to avoid possible overshoot in the charging current. The output of the current control operational amplifier comprises a current (I_{cntl2}) and is used to generate the control signal 120.

The power output 30 also comprises a voltage. The power output is coupled to a voltage control operational amplifier 340. The reference voltage 260 is also coupled to the voltage control operational amplifier. The output of the voltage control operational amplifier 345 comprises a current (I_{cntl3}) and is also used to generate the control signal 120.

The temperature control operational amplifier 250 has an output 255. The control signal 120 is therefore generated by coupling together the output of the temperature control operational amplifier 255, the current control operational amplifier 325 and the voltage control operational amplifier 355. Each of these three outputs comprises a current. By coupling the outputs together, the three currents are summed together.

Advantageously, the battery charger of FIG. 4 provides combined temperature, current and voltage regulation using a single control signal and a single power control circuit.

In theory, the steady state temperature within the battery charger (i.e. at the hottest point) is given by Tⱼ:
Tⱼ=Tₐ+ΔT
ΔT=R_{TH}×Pᵢ=R_{TH}×I_{charge}×V_{d}
where Tₐ is the ambient temperature, Pᵢ is the power dissipation in the battery charger, I_{charge} is the charging current and V_{d} is the voltage between the power input and the power output.

The battery charger preferably determines the temperature within the battery charger. The thermal sensor gives a direct measurement of the temperature within the battery charger. However, the thermal model relates the temperature to the power dissipation of the battery charger. The temperature gauge hence comprises a temperature sensor and processes the power output according to a thermal model to thereby determine the temperature within the battery charger according to the power dissipation.

There may be some delay between the power output changing and a change in the temperature within the battery charger. The thermal model advantageously accounts for such dynamic thermal behavior of the battery charger. This ensures the stability of the thermal regulation feedback loop. The thermal model may be different for different embodiments, layouts, constructions and materials of the battery charger. In the preferred embodiment, the battery charger is fabricated, at least in part, on an integrated circuit.

This ensures the stability of the thermal regulation feedback loop. The thermal model may be different for different embodiments, layouts, constructions and materials of the battery charger. In the preferred embodiment, the battery charger is fabricated, at least in part, on an integrated circuit.

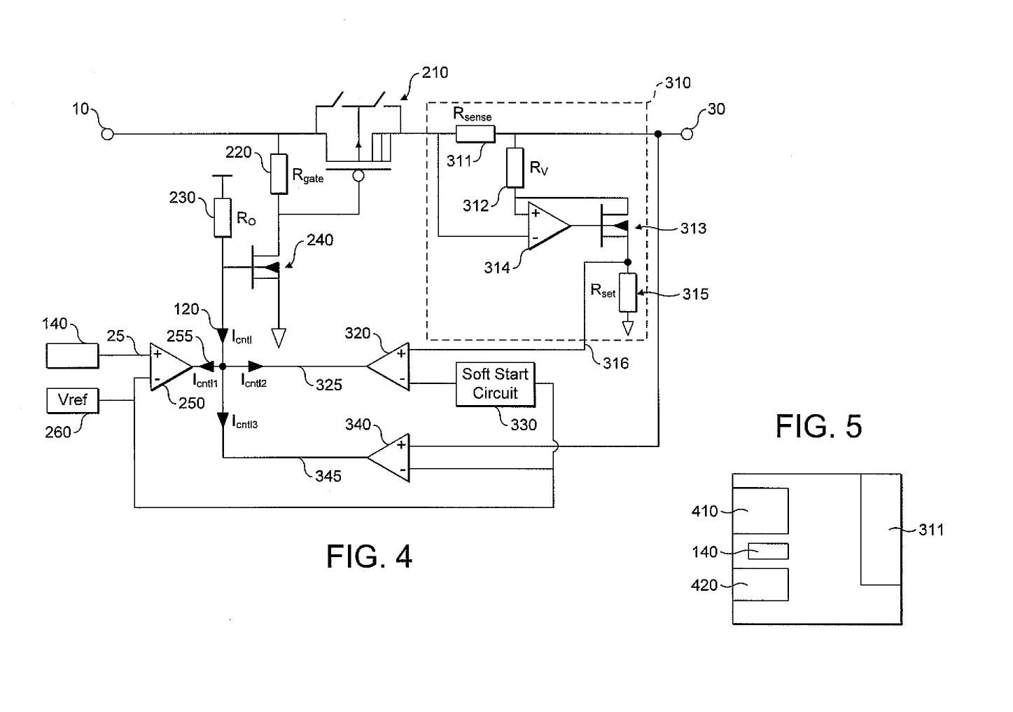

FIG. 5 shows a schematic layout of an integrated circuit package as an embodiment of a part of the battery charger of FIG. 4. The integrated circuit includes a main part 410, which may include the operational amplifiers of FIG. 4; the temperature gauge 140; the current sense resistor 311; and an interface portion 420. The interface portion may be a USB device. In a specific embodiment of the integrated circuit of FIG. 5, the area of the main part is 0.644 mm²; the interface portion 0.32 mm² and the current sense resistor 0.45 mm². The thermal model of the embodiment of the battery charger may be determined by analyzing the thermal characteristics of the battery charger.

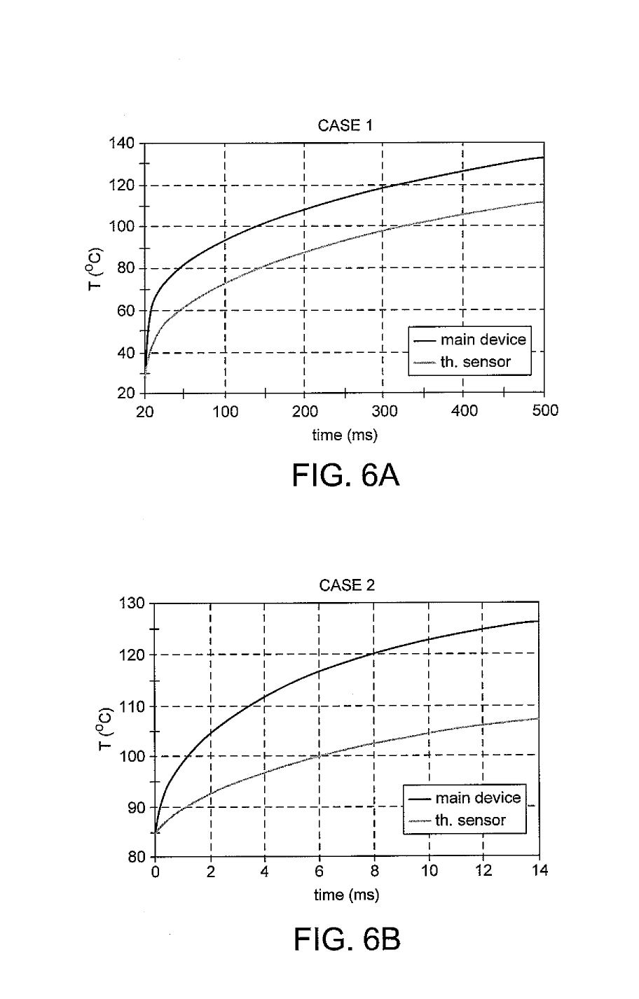

FIG. 6A and FIG. 6B show the variation of Tj against time for the embodiment of the battery charger in the integrated circuit package of FIG. 5, as obtained by thermal analysis for two different cases. A certain value of thermal resistance (R_{TH}) for the integrated circuit package is defined in units of ° C./W. For FIGS. 6A and 6B, R_{TH} is approximately 56° C./W, the power consumed by the main device is 3.52 W, the USB device is off and the power consumed by resistor Rₛₑₙₛₑ is 0.128 W.

For FIG. 6A, Tₐ is 25° C. After approximately 400 ms, Tⱼ rises to 125° C., which is an upper limit on the acceptable temperature. For FIG. 6B, Tₐ is 85° C. After 13 ms, Tⱼ rises to the 125° C. limit. There may be a temperature differential of approximately 20° C. between the chip hottest point and the thermal sensor.

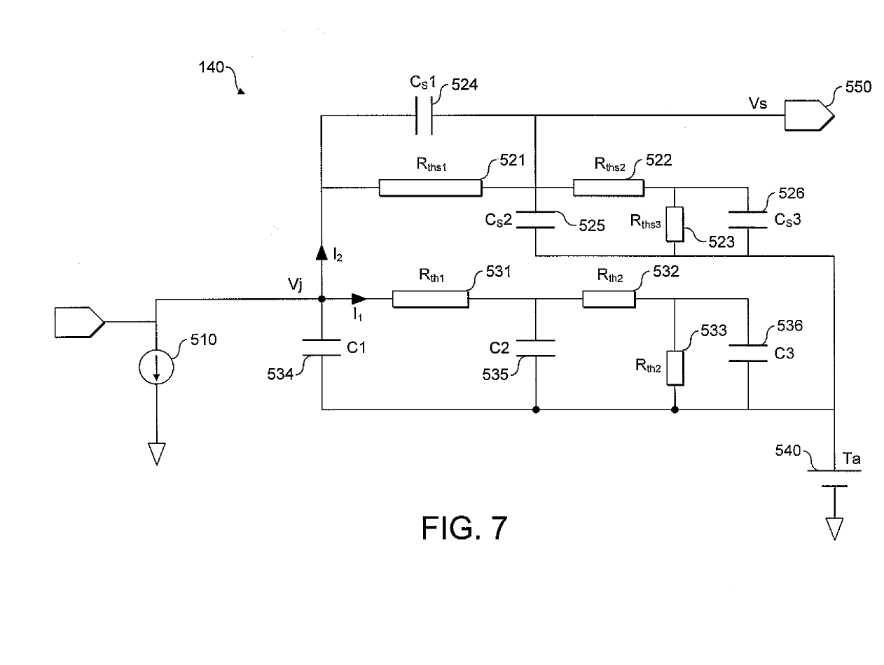

Based on these responses, FIG. 7 shows a circuit diagram of a temperature gauge arranged according to a thermal model of the battery charger as embodied by FIG. 5.

The model comprises a power to current converter 510, which measures the power output of the device and generates a current representative of the power output; resistors 521, 522, 523, 531, 532, 533 of resistance values Rₜₕₛ₁, Rₜₕₛ₂, Rₜₕₛ₃, Rₜₕ₁, Rₜₕ₂, and Rₜₕ₃ respectively; capacitors 524, 525, 526, 534, 535, 536 of capacitance values Cs1, Cs2, Cs3, C1, C2 and C3 respectively; voltage source 540; and voltage output 550. The voltage of the voltage source, Vₐ, is equivalent to that provided by a temperature measuring device when measuring temperature Tₐ. A temperature measuring device may optionally be provided to measure Vₐ. Currents I₁ and I₂ are also indicated.

At steady state, the voltage at point Vⱼ is given as follows:
Vⱼ=VₐI₁×(Rₜₕ₁+Rₜₕ₂+Rₜₕ₃).
This corresponds to the temperature at the hottest point of the device. The voltage at the output 550, Vₛ, at steady state is therefore:
Vₛ=Vⱼ−I₂×Rₜₕₛ₁.
This corresponds with the voltage at the output of the temperature gauge.

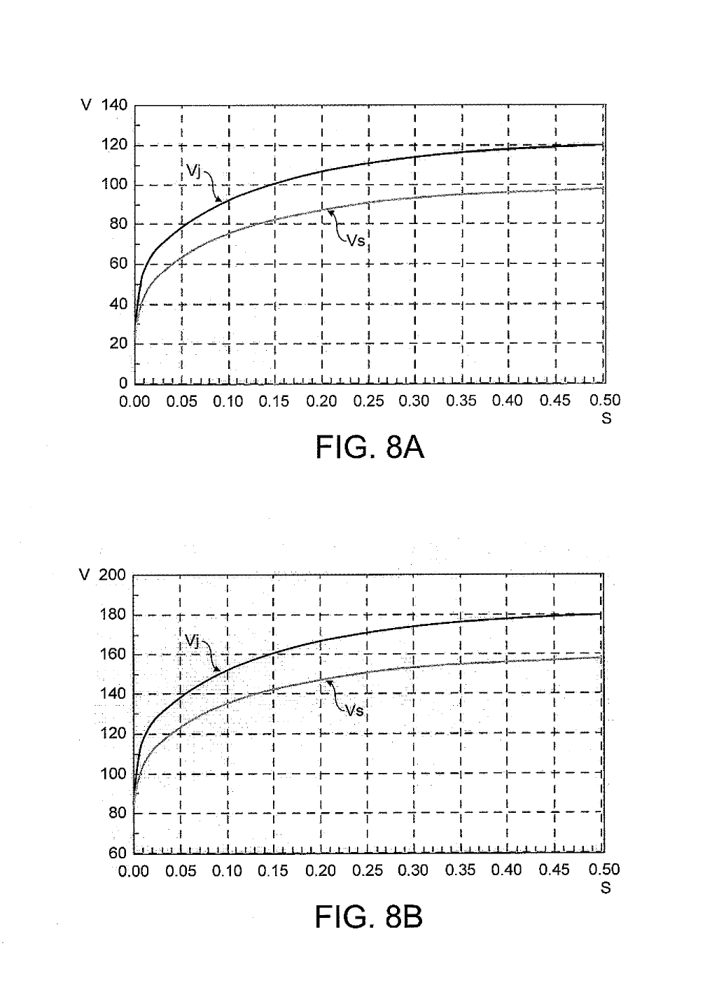

FIG. 8A shows the time response of the thermal model of FIG. 7, when in the same conditions as those used to obtain FIG. 6A. FIG. 8B shows the time response of the thermal model of FIG. 7, when in the same conditions as those used to obtain FIG. 6B.

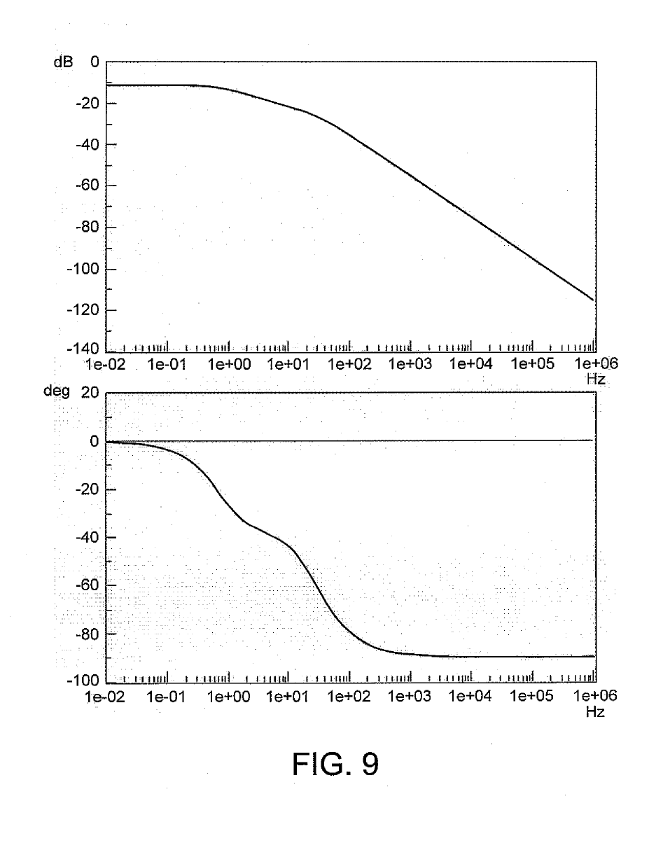

FIG. 9 shows the frequency and phase response of the thermal model of FIG. 7.

The open loop transfer function (TF) of the thermal feedback loop for the device of FIG. 3 may be given by the following expression:
TF=k×G_{TH}(s)×Gₐ₁(s)×G_{d}(s),
where k is a constant, G_{TH}(S) is the transfer function of the thermal model, Gₐ₁(s) is the transfer function of the operational amplifier 250 and G_{d}(s) is the transfer function of the power control circuit 110.

The frequency response for G_{TH}(s) is shown in FIG. 9. This indicates that the thermal model has a low frequency pole. This may be made the dominant pole in the loop by making the other poles from Gₐ₁(s) and G_{d}(s) non-dominant. Advantageously, no compensation is needed for the operational amplifier.

If the thermal behavior shows a fast response that leads to a high frequency pole in the extracted thermal model, then the dominant pole to stabilize the loop should be provided by compensating the operational amplifier 250.

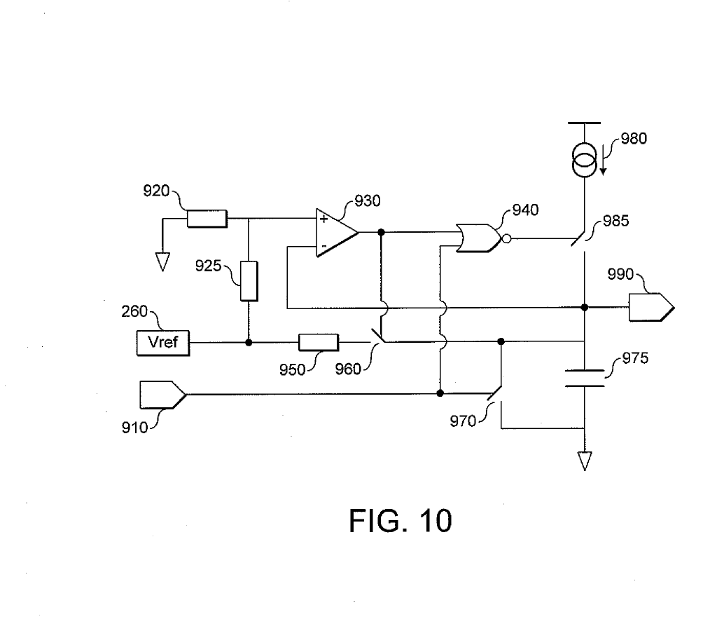

FIG. 10 shows a soft start circuit for use with the battery charger of FIG. 4. The circuit has two inputs: a voltage reference signal, the output of the reference voltage generator 260; and a charge start signal 910. The charge start signal is preferably a digital signal.

Resistors 920 and 925 are preferably configured such that the voltage at the point where the two resistors connect is 95% of the voltage reference signal. This voltage is provided as one input to comparator 930. The other input to the comparator is the circuit output 990. The output from the comparator is provided both to control switch 960, which connects the voltage reference signal, through resistor 950 to the output 990; and as an input to NOR gate 940. A second input to the NOR gate is provided by the charge start signal 910.

When the charging process starts, such that the charge start signal is high, switch 985 is closed and switches 960 and 970 are open. Hence, the output 990 is provided by a current source 980 which charges a capacitor 975. The output voltage therefore slowly ramps up, as the capacitor is being charged. When the output voltage reaches 95% of the voltage reference signal, the output of the comparator 930 becomes high. Hence, switch 960 is closed and switch 985 is opened. Then, the voltage output will rise to be the same as the reference voltage.

The soft start circuit provides a slow and linear ramping of the charge current. Hence a long soft start time can advantageously be achieved without the need for a big resistor.

While a specific embodiment has been described, the skilled person may contemplate various modifications and substitutions. For instance, temperature gauge has been described which converts a measured power output into a temperature measurement with dynamic behavior. Optionally the skilled person may instead consider alternative means for determining a temperature including sensors, such as a thermocouple device or a semiconductor temperature sensor.

Although the embodiments described use analogue signals, the skilled person will understand that digital signals may be equivalently used, together with digital logic controllers and analogue to digital and digital to analogue converters where necessary. The invention may be implemented at least in part on an integrated circuit. Alternatively, it may be implemented, at least in part, in discrete components, or using programmable logic, or in software.

The skilled person will also understand that the thermal model may be adapted for different embodiments and constructions of the battery charger.

Although preferred embodiments of the method and apparatus have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A battery charger having a power output to charge a battery, comprising:
a power input;
a circuit for determining a temperature at the battery charger which measures the power output and determines the temperature at the battery charger according to a thermal model for determining a dynamic variation in temperature at the battery charger based upon the measured power output; and
a controller which varies the power output among a plurality of non-zero power levels in dependence upon a difference between the determined temperature and a reference temperature.

2. A battery charger having a power output to charge a battery, comprising:
a power input;
means for determining a temperature at the battery charger; and
a controller which varies the power output among a plurality of non-zero power levels in dependence upon a difference between the determined temperature and a reference temperature.

3. The battery charger of claim 2, wherein the means for determining a temperature measures the power output and determines the temperature at the battery charger based upon the measured power output.

4. The battery charger of claim 2 wherein the means for determining a temperature comprises a temperature sensor measuring a temperature at the battery charger.

5. The battery charger of claim 2, wherein the power output of the battery charger has an output current and the controller varies the power output by varying output current.

6. The battery charger of claim 2 wherein the controller comprises a first comparator, arranged to generate a first control signal in dependence upon the difference between the determined temperature and the reference temperature.

7. The battery charger of claim 6, wherein the controller further comprises a power control circuit which varies the power output in dependence upon the first control signal.

8. The battery charger of claim 7, wherein the power control circuit comprises a transistor.

9. The battery charger of claim 6, wherein the first comparator comprises an operational amplifier.

10. The battery charger of claim 6, wherein the first control signal comprises a varying electrical current signal.

11. The battery charger of claim 2, wherein the power output of the battery charger has an output current and the battery charger further comprises:
a current meter for measuring the output current; and
wherein the controller varies the power output in dependence upon the output current.

12. The battery charger of claim 11 further comprising:
a soft start circuit which provides a soft start reference which increases towards a predetermined value; and
wherein the controller varies the power output in dependence upon a difference between the output current and the soft start reference.

13. The battery charger of claim 11 wherein the controller comprises:
a first comparator generating a first control signal in dependence upon a difference between the determined temperature and the reference temperature; and
a second comparator generating a second control signal in dependence upon a difference between the measured output current and a reference output current.

14. The battery charger of claim 13, wherein the second control signal comprises variations in an electrical current.

15. The battery charger of claim 13 wherein the controller further comprises:
a signal summer which sums the first control signal and the second control signal to generate a common control signal; and
a power control circuit which varies the power output in dependence upon the common control signal.

16. The battery charger of claim 2, wherein the power output of the battery charger has an output voltage and the battery charger further comprises:
a voltage meter for measuring the output voltage; and
wherein the controller farther varies the power output in dependence upon the measured output voltage.

17. The battery charger of claim 16, wherein the controller comprises:
a first comparator which generates a first control signal in dependence upon a difference between the determined temperature and the reference temperature; and
a third comparator which generates a third control signal in dependence upon a difference between the measured output voltage and a reference output voltage.

18. The battery charger of claim 17, wherein the controller further comprises:
a signal summer which sums the first control signal and the third control signal to generate a common control signal; and
a power control circuit which varies the power output in dependence upon the common control signal.

19. The battery charger of claim 11, wherein the power output of the battery charger has an output voltage and the battery charger further comprises:
a voltage meter for measuring the output voltage; and
wherein the controller varies the power output in dependence upon the output voltage.

20. The battery charger of claim 19, wherein the controller comprises:
a first comparator which generates a first control signal in dependence upon a difference between the determined temperature and the reference temperature;
a second comparator which generates a second control signal in dependence upon a difference between the measured output current and a reference output current; and
a third comparator which generate a third control signal in dependence upon a difference between the measured output voltage and a reference output voltage.

21. The battery charger of claim 20, wherein the controller further comprises:
a signal summer which sums the first control signal, the second control signal and the third control signal to generate a common control signal; and
a power control circuit which varies the power output in dependence upon the common control signal.

22. The battery charger of claim 21, wherein the third control signal comprises variations in an electrical current.

23. The battery charger of claim 2, wherein at least a part thereof comprises components fabricated on an integrated circuit.

24. The battery charger of claim 23 wherein the determined temperature is a temperature measured at a die of the integrated circuit.

25. A method of charging a battery using a battery charger having a power output, comprising:
determining a temperature at the battery charger; and
varying the power output of the battery charger among a plurality of non-zero power levels in dependence upon a measured size of the difference between the determined temperature and a reference temperature.

26. The method of charging a battery of claim 25, wherein determining comprises:
measuring the power output; and
determining the temperature at the battery charger based upon the measured power output.

27. The method of charging a battery of claim 25, wherein the power output of the battery charger has an output current and varying the power output comprises varying the output current.

28. The method of charging a battery of claim 27, further comprising:
measuring the output current; and
varying the power output in dependence upon the measured output current.

29. The method of charging a battery of claim 25, wherein the power output has an output voltage, and further comprising:
measuring the output voltage; and
varying the power output in dependence upon the measured output voltage.

30. A method of charging a battery using a battery charger having a power output, comprising:
determining a temperature at the battery charger by:
measuring the power output; and
determining dynamic variations in the temperature according to a thermal model based upon the measured power output; and
varying the power output of the battery charger among a plurality of non-zero power levels in dependence upon a measured size of the difference between the determined temperature and a reference temperature.

31. A battery charger having a power output to charge a battery, comprising:
a first circuit which senses a voltage at the power output and generates a first current control signal in response thereto;
a second circuit which senses a current supplied to the power output and generates a second current control signal in response thereto;
a third circuit which senses a temperature of the battery charger and generates a third current control signal in response thereto;
a summer for summing the first, second and third current control signals to generate a fourth current control signal;
a controller circuit which varies the power output of the battery charger among a plurality of non-zero power levels in response to the fourth current control signal.

32. The charger of claim 31 wherein the third circuit comprises a circuit for determining a temperature at the battery charger which measures the power output and determines the temperature at the battery charger according to a thermal model for determining a dynamic variation in temperature at the battery charger based upon the measured power output.
